(19) United States
(12) Patent Application Publication
(10) Pub. No.: US 2010/0314187 A1
(43) Pub. Date: Dec. 16, 2010

(54) ELECTRIC BICYCLE

(76) Inventor: CHUAN-SHENG CHEN, Taipei (TW)

Correspondence Address: LEONG C. LEI, PMB # 1008, 1839 YGNACIO VALLEY ROAD, WALNUT CREEK, CA, 94598, US

(21) Appl. No.: 12/861,845

(22) Filed: Aug. 24, 2010

Related U.S. Application Data
(63) Continuation-in-part of application No. 12/205,930, filed on Sep. 8, 2008.

(51) Int. Cl. B62M 23/02

(52) U.S. Cl. 180/205

(57) ABSTRACT

An electric bicycle is formed by user-manipulatively mounting a power driving assembly to a regular bicycle. The power driving assembly includes a driving gear, a flat motor, a battery set, an operation knob, and a transmission gear train. The driving gear is mounted to spokes of a bicycle wheel and is concentric with respect to an axle of the wheel. The flat motor is mounted to a frame of the wheel. The battery set is received in a casing, which is mounted to a frame of the bicycle and the operation knob is mounted on a handlebar of the bicycle or other suitable locations to control a switch of the flat motor, which transmits the power generated by the flat motor through the transmission gear train to drive the driving gear and thus controlling forwarding and stopping of the bicycle wheel, thereby realizing the operation and function of the electric bicycle.

### CROSS-REFERENCE TO RELATED APPLICATION

This is a continuation-in-part of the co-pending patent application Ser. No. 12/205,930.

### BACKGROUND OF THE INVENTION

(a) Technical Field of the Invention

The present invention relates to an electric bicycle, and in particular to an electric bicycle comprising a simple power driving assembly that can be easily and user-manipulatively mounted to a regular bicycle to convert the regular bicycle into an electric bicycle.

(b) Description of the Prior Art

A conventional electric bicycle comprises a motor and a battery set to serve as a power driving unit, which is mounted to a regular bicycle to convert the regular bicycle into an electric bicycle. Since a regular motor and the associated battery set occupy a substantial amount of space and have a substantial weight, it is generally not possible for a bicycle user to mount the motor and the battery to a bicycle by himself or herself. Thus, the general consumers are prevented from selecting their preferred bicycle model or riding a bicycle fit them and it is also not possible for the general consumers to additionally mount the power driving unit to their own regular bicycles to make an electric bicycle. Apparently, the conventional electric bicycle cannot satisfy the needs of the general consumers and, in addition, the riding burden and consumption of power are both increased, making the costs high and inducing damage to the environment. These are the major drawbacks of the conventional electric bicycles.

### SUMMARY OF THE INVENTION

The primary purpose of the present invention is to provide an electric bicycle, which can be formed by user-manipulatively mounting a power driving assembly to a regular bicycle and the power driving assembly comprises a driving gear, a flat motor, of which details are disclosed in a co-pending application that was filed as a patent application by the present applicant and is now issued a patent, a battery set, an operation knob, and a transmission gear train. The driving gear is mounted to spokes of a bicycle wheel and is concentric with respect to an axle of the wheel. The flat motor is mounted to a frame of the wheel. The battery set is received in a casing, which is mounted to a frame of the bicycle and the operation knob is mounted on a handlebar of the bicycle or other suitable locations to control a switch of the flat motor, which transmits the power generated by the flat motor through the transmission gear train to drive the driving gear and thus controlling forwarding and stopping of the bicycle wheel, thereby realizing the operation and function of the electric bicycle. The present invention allows an electric bicycle to be formed by simply and easily and user-manipulatively mounting a power driving assembly to a regular bicycle and allows the user to select the preferred model or a bicycle model suitable for the user's riding, or it is even possible to mount the assembly to a bicycle that is currently used by the user to make the electric bicycle to thereby substantially reduce the costs. The flat electrical motor used in the electric bicycle of the present invention is of the features of having a thin and flat configuration and lightweight. Thus, the structure of the electric bicycle in accordance with the present invention has never been proposed heretofore and has the advantages of labor and power saving and easy mounting and maintenance.

In view of the drawbacks that a conventional electric bicycle uses a regular motor and a power set to serve as a power driving device thereof; which prevents a user from making an electric bicycle by mounting the power driving device to a regular bicycle and also makes it impossible for the user to select a preferred model of bicycle or a bicycle suitable for riding.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating positional and assembling relationship among components of a power driving device in accordance with the present invention;

FIG. 2 is a side elevational view illustrating mounting of the present invention to a bicycle;

FIG. 3 is a schematic view illustrating an electric bicycle formed by properly mounting the present invention thereto;

FIG. 4 is an exploded view of a flat electrical generator constructed in accordance with the present invention;

FIG. 5 is a cross-sectional view of the flat electrical generator in accordance with the present invention;

FIG. 6 is a plain view of the arrangement of coils in accordance with a first embodiment of the present invention;

FIG. 7 is a plain view of the arrangement of coils in accordance with a second embodiment of the present invention; and

FIG. 8 is a plain view of the arrangement of coils in accordance with a third embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

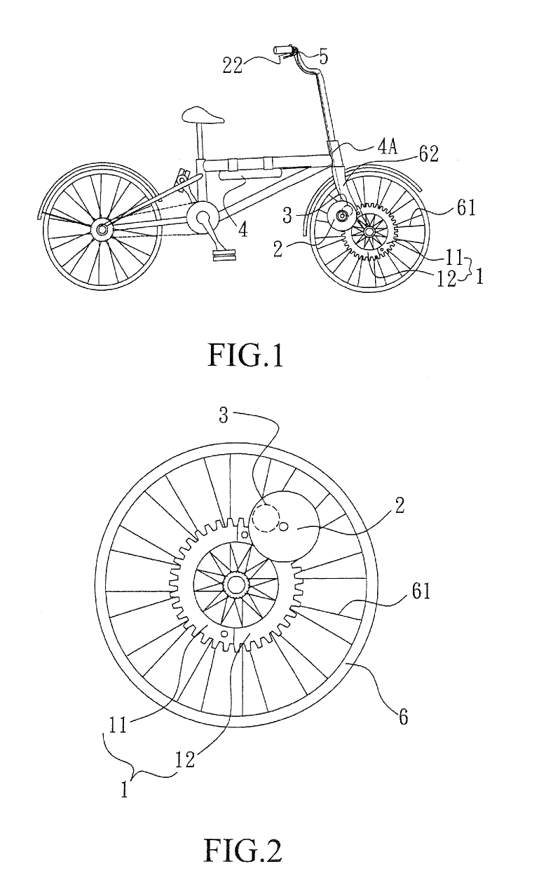

As shown in FIG. 1, the electric bicycle in accordance with the present invention is formed by combining a power driving assembly to a bicycle.

The power driving assembly comprises the following primary constituent components/parts: a driving gear 1, a flat electrical motor 2, a transmission gear train 3, a battery set 4, and an operation knob 5.

As shown in FIG. 2, the driving gear 1 is mounted to spokes 61 of a bicycle wheel 6 and is concentric with respect to an axle of the bicycle wheel 6 so that the mounting is easy and convenient. In a practical application, the driving gear 1 can be formed by combining two semi-circular toothed sections 11, 12 and a jointing surface comprises a spoke slot design to ensure the stability and reliability of jointing. The flat electrical motor 2 is fixed to a frame 62 for the bicycle wheel 6.

Referring to FIG. 1, the transmission gear train 3 is comprised of a first transmission gear 31 mounted to a power output spindle 21 of the flat electrical motor 2, a speed-change gear 32 mating the first transmission gear 31, and a second transmission gear 33 mounted to a shaft of the speed-change gear 32. The power output from the flat electrical motor 2 is transmitted from the first transmission gear 31 to the speed-change gear 32 and then further transmitted from the second transmission gear 33 mounted on the shaft of the speed-change gear 32 to the driving gear 1.

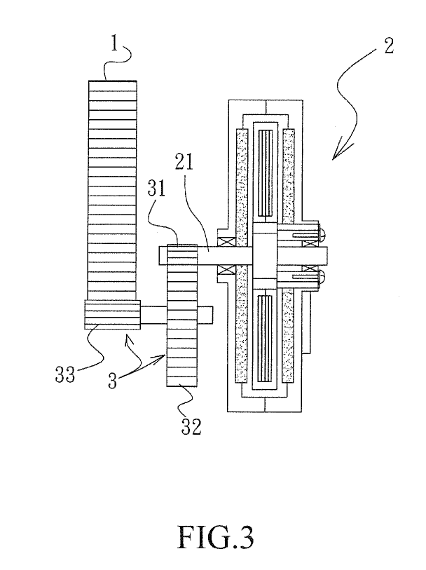

As shown in FIG. 3, the battery set 4 is contained in a casing and the casing is preferably mounted to a position on any appropriate portion of the bicycle frame, but can also be mounted to other locations to ensure easy mounting/dismounting and portably carrying, whereby losing of the battery set can be avoided and recharging can be easily done.

The operation knob 5 is arranged on a handlebar of the bicycle or other suitable locations. A switch 22 of the flat electrical motor 2 is preferably set in an operational relationship with the operation knob 5 in order to allow the operation knob 5 to control the switch 22.

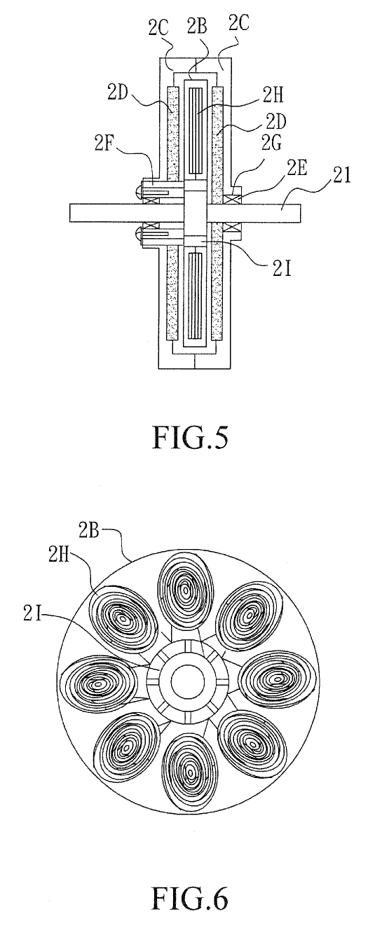

With reference to the drawings and in particular to FIGS. 3-8, the flat electrical motor 2 comprises a rotary disk 2B, two stationary disks 2C, a plurality of coils 2H, a plurality of magnets 2D, bearings 2E, carbon brushes 2F, and a shaft 21.

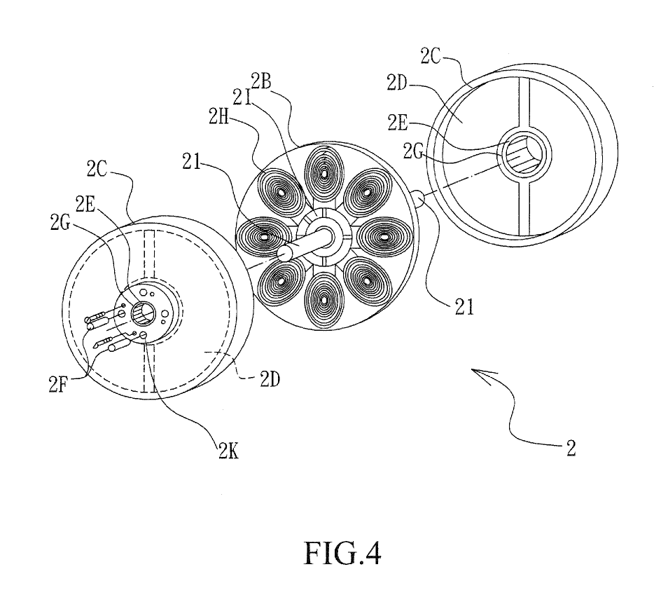

The coils 2H are formed by winding wires in a way that is different from the conventional motors in which the coils or windings are wound around an iron core. In a first embodiment of the present invention, as shown in FIGS. 4 and 6, each coil 2H is formed by a single wire that is wound as plural circular or elliptic turns that are substantially concentric or coincident with each other. The coils 2H that are so formed are then deposited in a mold that is used to form the rotary disk 2B, followed by plastic injection molding, so that the coils 2H are completely embedded in the rotary disk 1 that is formed by the injection molding. Each coil 2H has an exposed contact point (not labeled) that is put in physical engagement with a corresponding conductor terminal 21. The rotary disk 2B is fixed to the shaft 21 that extends through the rotary disk 2B so that opposite ends of the shaft 21 project beyond opposite faces of the rotary disk 2B.

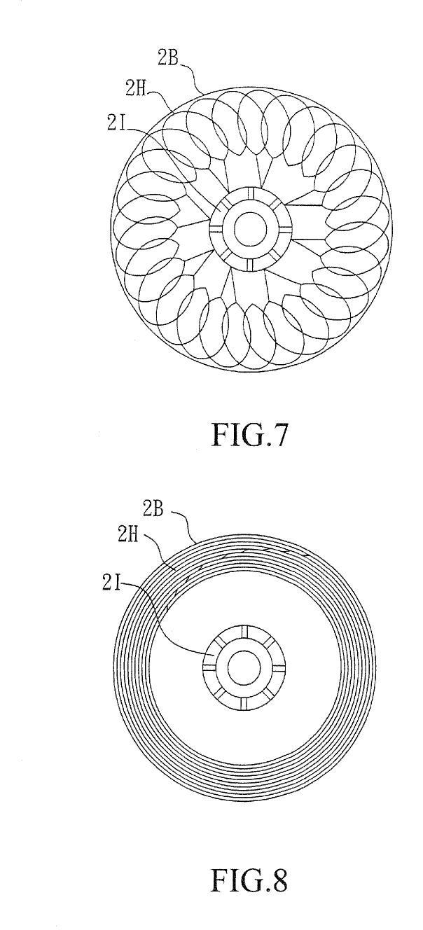

In accordance with a second embodiment of the present invention, as shown in FIG. 7, each coil 2H is formed by continuously winding a wire to form a plurality of turns that are at least partially offset with respect to each other.

In accordance with a third embodiment of the present invention, as shown in FIG. 8, the coils 3 are formed by winding wires in a concentric manner with respect to each other. In the embodiment illustrated in FIG. 8, four coils 2H are provided, which are concentric to each other.

The coils 2H of all the embodiments are combined with the plastics that make the rotary disk so that the material for forming the coils is reduced as compared to the conventionally core-wound coils. Thus, saving of cost can be achieved.

In a preferred embodiment, the magnets 2D are made semi-circular and two semi-circular magnets 2D form a group that is fixed to an inside face of each stationary disk 2C that is made of plastics. The stationary disk 2C forms a central bore 2G and the bearing 2E is received and fixed in the bore 2G A plurality of carbon brush holes 2K and a plurality of bolt receiving holes 2L are defined in the inside face of the stationary disk 2C and are respectively distributed along a circumference of the bore 2G The carbon brushes 2F are each received in the carbon brush holes 2K and are kept from falling out of the stationary disk 2C by retention bolts 2M received in the bolt receiving holes 2L.

The rotary disk 2D is coupled to the stationary disks 2C by means of the portions of the shaft 21 that project beyond the opposite faces thereof and fit into the bearings 2E fixed in the bores 2G of the stationary disks 2C, whereby the rotary disk 2B is positioned between the stationary disks 2C to form a basic configuration of the electrical motor.

When the operation knob 5 is actuated to turn on the switch 22, the battery set 4 will supply electrical current to the flat electrical motor 2 via a wire 4A. Then, the electrical current will pass through the coils 2H thereby causing the coils 2H to generate electromagnetism and therefore making the rotary disk 2B to rotate with respect to the stationary disks 2C.

The feature of the flat electrical motor 2 is that during operation, the magnets 2D are kept fixed while the coils 2H are put in rotation.

In the electrical motor of the present invention, the magnets induce magnetic fields in the gaps between the magnets on the two sides and the coils so that friction and abrasion caused therebetween can be substantially eliminated. This, together with the fact that the enameled wires that make the coils are embedded in the plastics that make the rotary disk, maintains the performance of the magnetic fields without undesired influence by any external factors and can effectively concentrate the magnetic field. In addition, when eccentricity occurs in the shaft or the bearings, wear of the enameled wires will not happen.

In accordance with the present invention, the coils 2H of the electrical motor 2 are embedded in the plastic rotary disk 2C and no winding around an iron core is needed. The magnets 2D are fixed to the two plastic stationary disks 2C. All these effect the result of reduction of weight, reduction of loading, reduction of material of the coils, ease of installation, and no wearing and no dissipation problem.

To conclude, in the electric bicycle in accordance with the present invention, the power driving assembly features small size, light weight, and easy and convenient mounting, and can be mounted to a preferred bicycle or a bicycle that is suitable to a user. The power driving assembly can be mounted to either the front wheel or the rear wheel with a handlebar carrying the operation knob to simplify the control and operation thereof. In addition, in case that the battery set runs out of power, the bicycle can be operated in the same way as a regular bicycle. Apparently, the present invention features low costs and high performance and easy mounting and maintenance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electric bicycle comprising: a frame; a handlebar mounted on said frame; a front wheel mounted on said frame and provided with spokes; a rear wheel mounted on said frame; a flat motor fixed to said front wheel and having a power output spindle and provided with a switch; a driving gear including two semi-circular toothed sections and mounted to said spokes of said front wheel; a transmission gear train including a first transmission gear, a speed-change gear, and a second transmission gear, said first transmission gear being mounted to said power output spindle of said flat motor, said speed-change gear mating said first transmission gear, said second transmission gear being mounted to a shaft of said speed-change gear, a battery set mounted on said frame; and an operation knob arranged on said handlebar for controlling said switch, wherein said electrical motor comprising:
a shaft; a rotary disk fixedly mounted on said shaft; a first stationary disk made of plastic and having a central bore in which is fitted a bearing, a plurality of brush holes and bolt receiving holes defined in an inside face of said first stationary disk and distributed along a circumference of said central bore; a second stationary disk made of plastic having a central bore in which is fitted a bearing; said rotary disk being coupled to said first and second stationary disks by means of portions of said shaft that project beyond opposite faces of said stationary disks and fit into said bearings fixed in said bores of said stationary disks, thereby positioning said rotary disk between said stationary disks; a plurality of carbon brushes each received in a respective one of said carbon brush holes of said first stationary disk and fixed by retention bolts received in a respective one of said bolt receiving holes; a plurality of coil sets each formed by continuously winding a wire to form a plurality of turns that are at least partially offset with respect to each other, said coil sets being completely embedded in said rotary disk; two first semi-circular magnets fixed to an inside face of said first stationary disk; and two second semi-circular magnets fixed to an inside face of said second stationary disk.

2. The electric bicycle as claimed in claim 1, wherein each of said coils has an exposed contact point that is put in physical engagement with a conductor terminal.
